(19) United States
(12) Patent Application Publication
(10) Pub. No.: US 2005/0261738 A1
(43) Pub. Date: Nov. 24, 2005

(54) Simulated breast comfort aide system

(76) Inventor: Vanessa Lynn Blevins Garrett, Oak Hill, VA (US)

Correspondence Address: VANESSA, L. B. GARRETT, 9912 WYNCLIFF COURT, LOUISVILLE, KY, 40241, US

(21) Appl. No.: 10/847,970

(22) Filed: May 19, 2004

(51) Int. Cl. A61J 17/00

(52) U.S. Cl. 606/234

(57) ABSTRACT

An improved comfort aide system for providing breastfed babies with the comforting sensory experience of non-feeding suckling at a breast resembling that of a mother's breast in: smell, form, feel and function. Comprising a main body portion of latex or silicone material, filled with liquid or other filler substance, shaped like a human female breast. A cover having the tactility of human skin encloses the main body. The cover may be saturated, sprayed or sprinkled with mom's breast milk. Cover dries and retains the smell of mom and her milk. Cover has a rear opening flap for permitting removal of the main body. Cover has a hole placed opposite to opening flap for nipple placement. The nipple, comprising areola, teat, and nipple base is attached through cover hole and is suckled by baby in the same manner baby would suckle to mom's natural lactating breast.

### CROSS REFERENCES TO RELATED APPLICATIONS

Not Applicable

### STATEMENT REGARDING FEDERALLY SPONSORED RESERCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

1. Field of Invention

This invention relates to child comforting systems, specifically a comfort aide which has the form, feel, smell and function of a human lactating breast.

2. Discussion of Prior Art

Parents, doctors and the United States Government recognize breastfeeding as the best source of nutrition for baby. The quality of mother's milk is superior to prepared formulas. Healthcare professionals agree that an infant's sensory experience is particularly important in the formidable stages of development. A mother providing her baby with her breast and the comfort the breast brings is an important aspect of proper child development and bonding between mother and baby.

A baby, and in particular, a breastfed baby innately yearns to be close to its mother's lactating breasts, as frequently as possible, for the breasts offering of nutritional sustenance; for the breasts scent; the breasts comfort and the breasts tactility, Even when a breastfed baby is not in the act of nursing, in other words drinking milk, baby often remains latched onto the breast to suck on the teat, which is commonly referred to as the nipple, possible including a small part of the areola, without drawing milk. In other words, the baby engages in a non-feeding or non-eating suckling session, purely for the comfort gained from mom's familiar breast milk scent; the comfort gained from sucking; and the comfort drawn from being close to mom. The baby's desire to remain latched onto mom's nipple, in non-feeding suckling sessions, can and often does hinder the mom's and other care-givers day and evening routines. For example, breastfed babies rarely sleep through the night, waking up several times during the night. Many of these sleep interruptions occur due to the baby's desire to latch-on to mom's breast and suck for comfort, without drawing out much, if any milk at all.

A breastfed baby awakes during the night seeking the comforting familiar scent of mom's lactating breasts. As a result, parents' and caregivers sleep' is interrupted several times in any given night. Parents with breastfed children attest to their desire to have their children sleep uninterrupted for longer periods of time and for the parents' need for more sleep.

Weaning a breastfed baby also poses several challenges and difficulties. Baby is unwilling to give up the comfort of snuggling and suckling on mom's supple fragrant breast. A breastfed baby typically resists mom's attempt to limit nursing sessions and non-feeding suckling sessions.

Parents and caregivers use prior art products like pacifiers, pillows, and toys in various combinations in an attempt to comfort baby, however, the prior art can be cited for abundant shortcomings. The greatest shortcoming of the prior art being the unnaturalness of suckling or sucking on objects which neither resemble nor smell like mom's lactating breast. The use of the prior art for non-feeding suckling has resulted in a predominance of unnatural sensory experiences.

The use of a pacifier pillow is known in the prior art, U.S. Pat. No. 5,534,014 to Demeritt (1996) describing an elongated pacifier pillow, an apparatus which attempts to fulfill an infants desire to bite and grasp objects. Though the pillow is soft to baby's touch, the elongated shape does not replicate the form, or the function, or the smell of the natural lactating breast.

U.S. Pat. No. 5,665,113 to Decker (1997) describes a pacifier attached to a pillow which also attempts to comfort child with the use of a soft comforting surface. The prior art, however, does not provide the sensory experience of mom's familiar breast scent and shape. U.S. Pat. No. 6,681,944 to Youssef (2004) describes an infant feeding container which attempts to imitate a human breast. This prior art fulfills its function as a feeding device, but it requires many component parts for manufacture and does not provide the functionality of a comfort aide non-feeding system. U.S. Pat. No. 5,993,479 to Prentiss (1999) describes an infant feeding container for a simulated breast nurser. This prior art fulfills its function as a feeding device, but it requires many component parts for manufacture and does not provide the functionality of a comfort aide non-feeding system. U.S. Pat. No. 5,344,355 to Silverstein (1994) describes a toy with a detachable pacifier, the prior art presents a nipple for suckling; however, it does not simulate the beneficial sensory experience. U.S. Pat. No. 5,908,439 to Ford (1999) describes a nipple attached to an elongated member having a cloth covering which is soft to the touch, however, the shape is unnatural and does not replicate the form, nor function, nor smell of the natural lactating breast. U.S. Pat. No. 5,391,184 to Rosenthal (1995) describes a nipple connected to a bracelet to be worn around a child's wrist; addressing the problem of lost or misplaced pacifiers, however, the prior art does not offer the natural sensation of being close to a mother's lactating breast.

While the prior arts devices fulfill their respective, particular objectives and requirements, the aforementioned patents do not meet the need for a comfort aide system which is superior in function.

The prior arts use of pacifiers with nipples do not provide a sensory experience similar to the comforting feeling of latching-on to a supple, fragrant breast and engaging in non-feeding suckling.

### BRIEF SUMMARY OF THE INVENTION

The present invention meets the needs presented above by substantially imitating the form, feel, smell and function of a natural lactating and a non-lactating breast. The present invention satisfies the breastfed baby's yearning to suckle at mom's breast; to smell the aroma of mom's breast milk; to fondle mom's supple breast; and comforts baby with the familiar size, shape, color, and smell of mom's breast.

The present invention a comfort aide system meets the physical and emotional needs of breastfed baby and formerly breastfed baby to be in proximity to and to latch on to a milk scented breast.

The present invention comprises a crested dome shape, configured to look like a human female breast; having a supple quality; a cover having the tactility of human skin; and nipple portion comprising an areola, a teat and a nipple base. The present invention's design is easily laundered; visually resembles a mom's breast; feels like mom's lactating breast; has the versatility to smell like mom's lactating breast and comforts baby as mom's lactating breast.

### OBJECTS AND ADVANTAGES

Accordingly, several objects and advantages of the present invention exist. The first object is to provide a comfort aide system to comfort baby with out feeding baby, with a system resembling the human female breast, which is the entity breastfed babies most desire. A second object is to provide a comfort aide system which smells like baby's mother's breast milk. A third object is to provide a comfort aide system which visually resembles baby's mother's lactating breast. A fourth objective is to provide a comfort aide system to help ease the weaning process. A fifth objective is to provide a comfort aide system which helps make baby's temporary physical separation mother easier. A sixth objective is to provide a comfort aide system which comes closest to providing baby with the comforting sensation baby's mother gives with her breast. A seventh objective is to provide a comfort aide system which assists baby put him/herself back to sleep without mom's actual breast to suckle; thereby giving the parents/caregivers more uninterrupted sleep. An eighth objective is to provide a comfort aide system which is portable and can be used in various places, such as a crib, car seat, sitting up, laying down. A ninth objective is to provide a comfort aide system which is easy to maintain and clean. The tenth objective is to provide a comfort aide system which uses few parts to manufacture and requires easy assembly. An eleventh objective is to provide a comfort system which feels like a human lactating breast and provides a beneficial sensory experience for baby.

Further objects and advantages of the present invention will become apparent from a consideration of the drawings and ensuing description.

### BRIEF DESCRIPTION OF DRAWINGS

FIG. 1 is a perspective view of a new simulated breast comfort aide system.

FIG. 2 is a rear view of the present invention including a fastening device of cover.

FIG. 3 is an elevational view of the present invention.

FIG. 4 is a cross sectional view of additional embodiments which includes a filled main body, and a removable cover.

FIG. 5 is a perspective view of the filled main body.

FIG. 6 is an elevational view of cover.

FIG. 7 is a perspective view of nipple portion.

### LIST OF REFERENCE NUMERALS

5 simulated breast comfort aide system

10 main body

20 nipple portion

20A areola

20B teat

20C nipple base

30 filler substance

40 cover

50 opening flap

55 fastening device

60 cover hole

80 crested first end

90 second end

### DESCRIPTION OF INVENTION

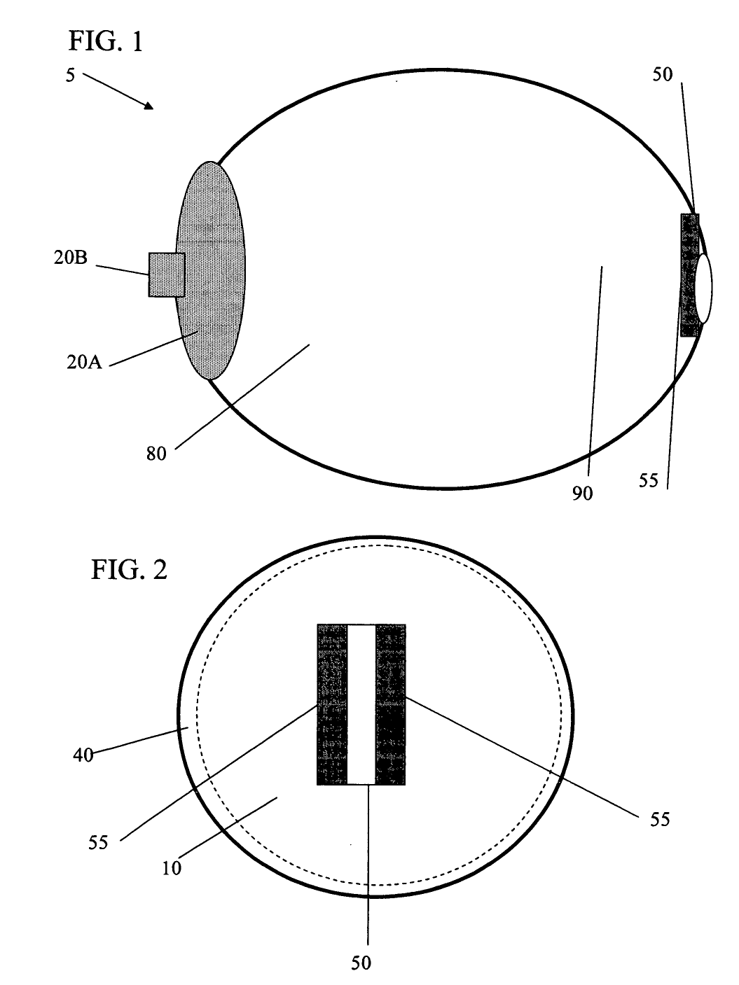

With reference now to the drawings, and in particular to FIGS. 1 through 7 thereof, a new simulated breast comfort aide system embodying the principles and concepts of the present invention and generally designated by the reference numeral 5 will be described.

Illustrative FIG. 1 discloses a simulated breast comfort aide system 5 having a nipple 20B and areola 20A attached to main body 10 by a cover 40 at the cresting first end 80. The simulated breast comfort aide system 5 of FIG. 1 further discloses a second end 90 having fastening device 55 attached at opposite ends of opening flap 50. Velcro™, Velcro USA Inc., Manchester, N.H., strips are employed in the depicted example. Fastening device 55 may be any suitable type of fastening device such as a hook-and-loop fastener, snaps, buttons, etc.

Illustrative FIG. 2 discloses a rear view of the second end 90 detailing the cover 40 attached to the exterior surface of main body 10. Main body 10 is comprised of silicone or latex or other material which provides a soft, supple and squeezable characteristic of the simulated breast comfort aide system 5. Main body 10 is designed for holding a filler substance 30. Filler substance 30 in the present embodiment is water, however, any group of material my be selected form the group of non-toxic gel type materials, silicone, or water cells applied in an amount which would provide soft supple and squeezable characteristics of the simulated breast comfort aide system 5. Main body 10 of breast simulating comfort aide system 5 simulates various breast sizes and degrees of suppleness of the human female lactating breast. In an embodiment, main body 10 is comprised of a silicone or latex material, a filler substance 30 such as water, silicone or other suitable substance is positioned within main body 10 and sealed within the main body 10. Main body 10 when filled with filler substance 30 maintains a degree of firmness and suppleness in order to remain pliant; thereby maintaining the quality of a lactating human breast.

Illustrative FIG. 6 discloses shape of cover 40, without main body 10 in its interior. Cover 40 having a cover hole 60 for nipple placement.

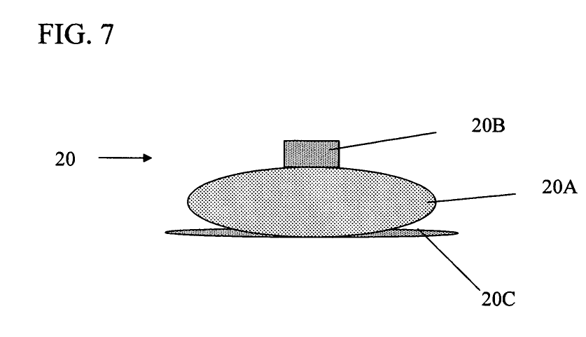

Illustrative FIG. 7 discloses a nipple portion 20 comprising a nipple base 20C, areola 20A and teat 20B. Areola 20A and teat 20B comprised in nipple portion 20 visually simulate the anatomy of the human female breast. Nipple 20 should be formed of a substantially resilient material such as rubber, latex or other conventionally known resilient materials. A nipple designed to be similar in shape to a mother's nipple during breast feeding, elongating when baby sucks, is preferable. The preferred embodiment illustrated for Nipple 20 is a Playtex Nurser System Natural Action Nipple™, Playtex Products Inc., Dover, Del., bottle nipple which comes in a dark color resembling the areola and nipple of a human female breast. In addition, the Playtex Natural Action Nipple™ is larger then most commercially sold nipples, so it more closely resembles the size and shape of a human female breast. Any variety of commercially available non-toxic, synthetic nipples may be used.

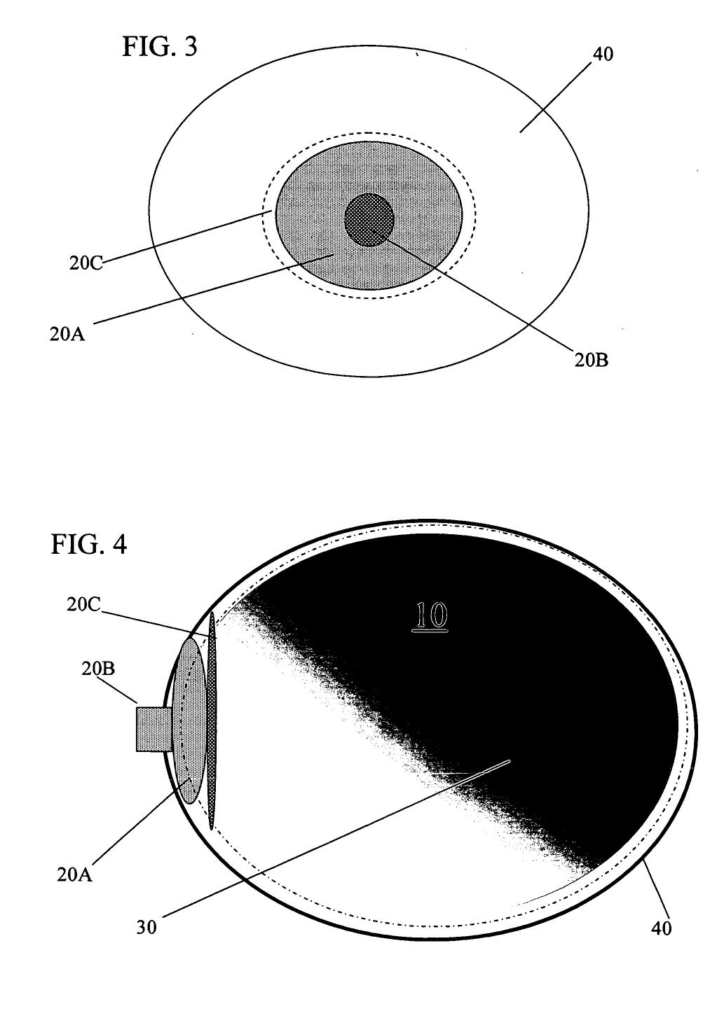

Illustrative FIG. 3 discloses an elevational view of the cover 40 on the exterior surface of main body 10. Cover 40 simulates the feel of human skin, smooth and comforting to baby's touch, stimulating baby's senses. In an embodiment, cover 40 is comprised of nylon/spandex blend, similar to that of a woman's seamless bra cup from a brassiere sold in department stores; or other synthetic material having a friendly tactile quality which feels like human skin. Cover 40 is embodied in various skin tones to resemble skin tones of blacks, whites, Hispanics, Asians, etc. Cover 40 in operation is saturated, sprayed or sprinkled with mom's breast milk. Breast milk dries on cover 40, leaving cover 40 with the inviting and familiar scent of mom's breast milk. Cover 40 is removable for washing. Nipple base 20C is placed into cover hole 60 at cresting first end 80 and nipple base 20C is securely held in place on main body 10 by cover 40. The areola 20A and teat 20B of nipple portion 20 protruding through cover hole 60 extending beyond main body 10. Nipple base 20C of nipple portion 20 may be held in place by cover 40 if nipple portion 20 is not permanently affixed to main body 10.

Illustrative FIG. 4 discloses a cross sectional view of main body 10 with filler substance 30 positioned within main body 10; with main body 10 having the shape and form of a human lactating breast. Cover 40 is attached to the exterior surface of filled main body 10. Nipple base 20C positioned on main body 10 securely held in place by cover 40.

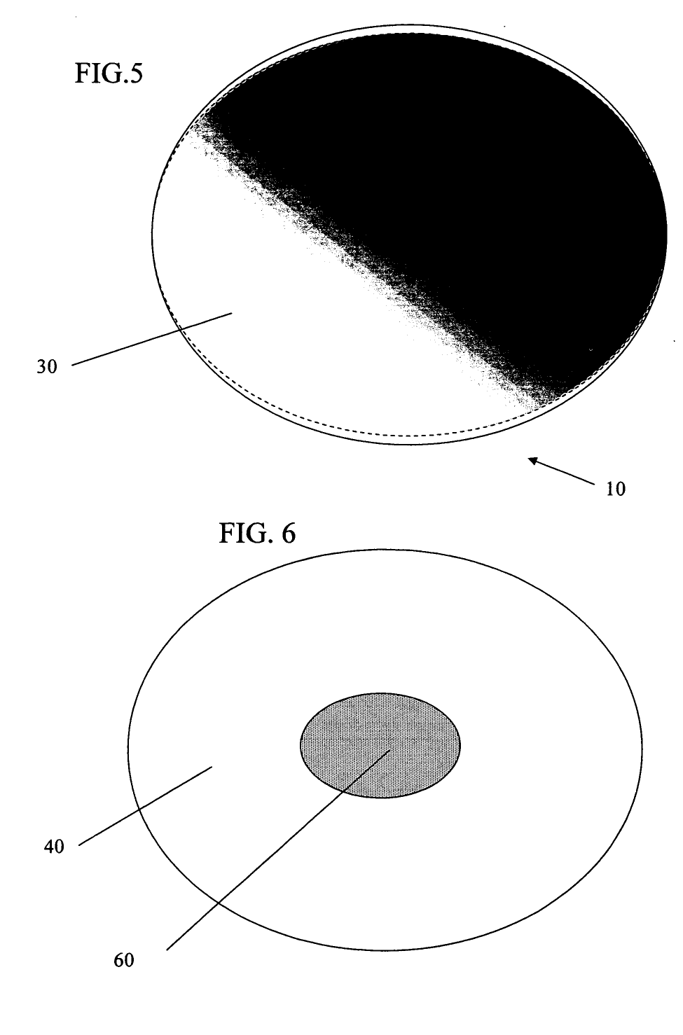

Illustrative FIG. 5 discloses main body 10 with filler substance 30 positioned within main body 10.

### OPERATION OF INVENTION

Main body 10 of breast simulating comfort aide system 5 simulates various breast sizes and degrees of suppleness of the human female lactating breast. In an embodiment, main body 10 is comprised of a silicone or latex material, a filler substance 30 such as water, silicone or other suitable substance is positioned within main body 10 and sealed within the main body 10. Main body 10 when filled with filler substance 30 maintains a degree of firmness and suppleness in order to remain pliant; thereby maintaining the quality of a lactating human breast.

Baby will hold, squeeze, fondle, caress and manipulate main body 10 with cover 40 attached to the exterior surface of main body 10 as a breast feeding baby does while suckling at its mothers breast. Cover 40 simulates the feel of human skin, smooth and comforting to baby's touch, stimulating baby's senses. Cover 40 simulates skin, manufactured in various skin hues and tones; visually resembling the skin color and hue of mom's actual breast. Cover 40 in operation is saturated, sprayed or sprinkled with mom's breast milk. Breast milk dries on cover 40, leaving cover 40 with the inviting and familiar scent of mom's breast milk. Cover 40 may be re-saturated with breast milk any number of times. In an embodiment, cover 40 is comprised of nylon/spandex blend, similar to that of a woman's seamless bra cup from a brassiere sold in department stores; or other synthetic material having a friendly tactile quality which feels like human skin. Cover 40 embodied in various skin tones to resemble skin tones of blacks, whites, Hispanics, Asians, etc. Cover 40 is removable for washing.

Main body 10 is inserted into cover 40 and removed from cover 40 through opening flap 50 on the perimeter of cover 40. Opening flap 50 is positioned at the second end 90 of main body 10. Opening flap 50 is closed by fastening device, 55. A fastening device 55 is assembled on opposite ends of opening flap 50. Opposite ends of fastening device 55 are brought together to close Opening flap 50. Velcro™, Velcro USA Inc., Manchester, N.H., strips are employed in the depicted example. Fastening device 55 may be any suitable type of fastening device such as a hook-and-loop fastener, snaps, buttons, etc.

Nipple 20 is inserted through cover hole 60 of cover 40, with nipple base 20C resting on the crested first end 80. Cover 40 holds nipple 20 tightly and securely in place against main body portion 10. Nipple 20 may be appropriately reinforced in other ways. Nipple 20 comprises an areola 20A, teat 20B and nipple base 20C. Areola 20A and teat 20B comprised in nipple 20 visually simulate the anatomy of the human female breast. Baby wraps its mouth around the teat 20B and a minute portion of the areola 20A as if suckling its own mothers lactating breast. Nipple 20 should be formed of a substantially resilient material such as rubber, latex or other conventionally known resilient materials. A nipple designed to be similar in shape to a mother's nipple during breast feeding, elongating when baby sucks, is preferable.

The preferred embodiment illustrated for Nipple 20 is a Playtex Nurser System Natural Action Nipple™, Playtex Products Inc., Dover, Del., bottle nipple which comes in a dark color resembling the areola and nipple of a human female breast. In addition, the Playtex Natural Action Nipple™ is larger then most commercially sold nipples, so it more closely resembles the size and shape of a human female breast. Any variety of commercially available non-toxic, synthetic nipples may be used.

### DESCRIPTION AND OPERATION OF ALTERNATIVE EMBODIMENTS CONCLUSION, RAMIFICATIONS AND SCOPE OF INVENTION

Thus the reader will see that the simulated breast comfort aide system provides a satisfying substitute for mom's breast. The present invention is a comfort aide system which baby can snuggle, suckle, smell, caress and fondle, to satisfy baby's need to be close to mom's breast, and baby's need for non-feeding suckling sessions.

While my above description contains much specificity, these should not be construed as limitations on the scope of the invention, but rather as an exemplification of one preferred embodiment thereof. Many other variations are possible. Alternative embodiments of the nipple include a nipple incorporated and permanently affixed to the main body; nuances in nipple shape; nuances in color; various means of attachment of nipple to cover; or other adjustments within the scope of the invention. Embodiments of the main body portion include latex, rubbers, silicone, foam or any other material which holds its shape, is pliable and is safe for use. The main body portion may be filled with water, saline solution, silicone gel, other non-toxic gels, foam or any other type of material which provides soft, supple and squeezable characteristics for the simulated breast comfort aide system. The main body portion may be produced in various human breast sizes, similar to the breast size cups of women. Alternative cover embodiments include nylon, spandex, nylon-spandex blend, cotton, cotton-polyester blend or any other material which has the tactile quality of human skin. The cover can be embodied in various ethnic skin tones representing blacks, whites, Asians, Hispanics and the like. Alternative fastening device embodiments include any safe means by which to latch close the flaps of the cover.

The present invention principally attempts to imitate the comforting sensory experience of non-feeding natural breast suckling. While the formulation of new materials and processes may enable enhancements in future designs, the claims anticipate such evolution, permitting appropriate design alternatives within the broader scope. Accordingly, the scope of the invention should be determined not by the embodiments(s) illustrated, but by the appended claims and their legal equivalents.

1. A simulated breast comfort aide system comprising
a main body domed shaped member having a crest resembling that of a woman's lactating breast, constructed of a pliable material having a crested first end and a second end;
a filler substance;
a cover, substantially shaped in form to encase said main body resembling a woman's lactating breast and;
a nipple portion having a teat, areola and nipple base;
a means for said filler substance to be applied into said main body and a means to seal said filler substance into said main body, said filler substance maintains said main body's breast form; said cover coupled to exterior surface of said main body; the improvement wherein said cover is constructed of material which maintains or holds an amount of human breast milk sufficient to emanate the smell of said human breast milk; said nipple being operationally couplable to said main body with said nipple base being in environmental communication with said main body; said nipple portion's areola and teat being position-able to extend beyond said crested first end of said main body; whereby a baby can suckle said nipple and cuddle said simulated breast comfort aide system and draw comfort from said simulated breast comfort aide system while in sitting or lying position.

2. The simulated breast comfort aide system of claim 1 further including an opening flap on perimeter wall of said cover facilitating access to said main body and a cover hole on the perimeter wall of said cover positioned opposite said opening flap; said cover is placed on the exterior surface of said main body with said cover hole positioned at said crested first end of said main body; said cover hole providing a means for said nipple base attachment.

3. The simulated breast comfort aide system of claim 1 wherein said cover is fabricated of a soft material selected from a list including natural and synthetic fibers, said cover simulating skin of human breast.

4. The simulated breast comfort aide system of claim 1 further including a plurality of covers, each one of said covers being operationally couplable to said main body individually, each one of said plurality of covers having a unique color or hue relative to each other, said plurality of covers representing a multitude of human skin colors.

5. The simulated breast comfort aide system of claim 2 further including a fastening device secured on opposite ends of said opening flap.

6. The simulated breast comfort aide system of claim 1, wherein said main body is composed of thermoplastic, elastomer, thermoset rubber, silicone rubber, latex, resilient foam material, or other pliant material.

8. A simulated breast comfort aide system comprising
a main body, said main body having inner solid core of soft silicone material resembling in consistency and specific weight the natural breast tissue shaped to resemble a human lactating breast;
a cover substantially conforming to the shape of said main body, resembling a woman's lactating breast and;
a nipple having a teat, areola and nipple base;
a filler substance;
a means for said filler substance to be inserted into said main body and a means to seal said filler substance into said main body, said cover coupled to exterior surface of said main body; and said nipple portion being operationally couplable to said main body with said nipple base being in environmental communication with said main body portion; the improvement wherein said cover's material maintains or holds an amount of human breast milk sufficient to emanate the smell of said human breast milk; whereby a baby can suckle said nipple and cuddle said simulated breast comfort aide system drawing comfort from said breast simulating comfort aide system while in sitting or lying position.
